(19) United States
(12) Patent Application Publication
(10) Pub. No.: US 2021/0226702 A1
(43) Pub. Date: Jul. 22, 2021

(54) VLC DATA FORWARDING BETWEEN WEARABLE DEVICE AND HOST DEVICE

(71) Applicant: YUYANG DNU CO., LTD., Hwaseong-si, Gyeonggi-do (KR)

(72) Inventors: Sangok KIM, Seoul (KR); Byungoh KIM, Suwon-si (KR); Sang-ho YOON, Suwon-si (KR); Seung-wan ROH, Suwon-si (KR)

(21) Appl. No.: 16/759,379

(22) PCT Filed: Mar. 12, 2018
(86) PCT No.: PCT/KR2018/002885

§ 371 Date: Apr. 27, 2020

(30) Foreign Application Priority Data
Oct. 31, 2017 (KR) 10-2017-0144079

(51) Int. Cl. H04B 10/116; H04W 4/80

(52) U.S. Cl. CPC H04B 10/116; H04W 4/80

(57) ABSTRACT

The present disclosure relates to visible light communication (VLC) data forwarding between a wearable device and a host device. The wearable device having a VLC receiver can receive a visible light communication signal from a VLC transmitter and deliver or forward a data packet demodulated from the visible light communication signal to the host device paired therewith.

### CROSS-REFERENCE TO RELATED APPLICATION

This application claims priority from Korean Patent Application No. 10-2017-0144079 filed on Oct. 22, 2017, the disclosure of which is incorporated by reference herein in its entirety.

### TECHNICAL FIELD

The present disclosure relates generally to visible light communication (VLC). More particularly, the present disclosure relates to forwarding VLC data by a wearable device having a VLC receiver to a host device.

### BACKGROUND

The statements in this section merely provide background information related to the present disclosure and do not necessarily constitute prior art.

Visible light communication involves the transmission of information through modulation of the light intensity of a light source, e.g., modulation of light intensity of one or more light emitting diodes or LEDs. In general, visible light communication is achieved by transmitting a modulated visible light signal from a light source, such as an LED or laser diode (LD), and receiving and processing the modulated visible light signal by a receiver (e.g., a mobile device) having a photodetector (PD) or a PD array (e.g., a CMOS image sensor such as a camera.

Thanks to their improving light emitting efficiency and falling cost, LEDs are becoming commonplace in general lighting applications in residential, commercial, outdoor, and industrial market fields. LEDs are becoming commonplace in special lighting applications, such as portable devices, display devices, vehicles, sign lamps, signs, and the like, too. An LED through undetectably high-speed modulation for humans can transmit data at a high speed.

The linearity of the light source used for visible light communication requires an alignment between a receiver (e.g., a smartphone) that receives visible light and a transmitter that transmits the visible light. For example, a smartphone user will need to hold the smartphone to face the user by the screen and to direct a light-receiving element, such as a photodetector provided in the smartphone, toward the visible light transmitter. This limits user-friendliness.

### SUMMARY

### Technical Problem

The present disclosure focuses on overcoming or mitigating such drawbacks through forwarding VLC data by a wearable device (also referred to as an accessory device) with a VLC receiver to a host device paired therewith and allowing the host device (30) to provide the user with information based on the VLC data.

### Technical Solution

At least one aspect of the present disclosure provides a method performed by a wearable device, including performing a pairing with a host device to have a paired host device, receiving a visible light communication (VLC) signal broadcast from a visible light transmit device, and forwarding a data packet included in the VLC signal to the paired host device.

Another aspect of the present disclosure provides a wearable device including at least one processor, a memory, and at least one program stored in the memory and executable by the at least one processor. Here, the at least one program includes instructions for performing a pairing with a host device to have a paired host device, instructions for receiving a visible light communication (VLC) signal broadcast from a visible light transmit device, and instructions for forwarding a data packet included in the VLC signal to the paired host device.

Yet another aspect of the present disclosure provides a wearable device including a means configured to receive a visible light communication (VLC) signal broadcast from a visible light transmit device, a means configured to perform a pairing with a host device to have a paired host device, a means configured to establish a connection with the paired host device, and a means configured to forward a data packet included in the VLC signal to the paired host device.

### Advantageous Effects

According to some embodiments of the present disclosure, a user can align a wearable device that is nimbly maneuverable with a visible light transmit device to receive a visible light signal, for example by the user with a wearable glasses gazing at the visible light transmit device or the user with a wearable watch directing his or her wrist toward the visible light transmit device, while a host device can, without having to be aligned with the visible light transmit device, use a data packet included in the visible light signal forwarded from the wearable device.

### BRIEF DESCRIPTION OF THE DRAWINGS

FIG. 1 is a diagram of an exemplary overall configuration of a visible light communication-based information providing system according to at least one embodiment of the present disclosure.

FIG. 2 is a block diagram of a VLC transmit device according to at least one embodiment of the present disclosure.

FIG. 3 is a block diagram of a wearable device and a host device paired with each other according to at least one embodiment of the present disclosure.

FIG. 4 is a block diagram of a wearable device according to at least one embodiment of the present disclosure.

FIG. 5 is a block diagram of a host device according to at least one embodiment of the present disclosure.

FIG. 6 is a flowchart of a VLC data forwarding method according to at least one embodiment of the present disclosure.

FIG. 7 is a flowchart of a VLC data forwarding method according to another embodiment of the present disclosure.

### DETAILED DESCRIPTION

Hereinafter, some embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely for the purpose of differentiating one component from the other, not to imply or suggest the substances, the order or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

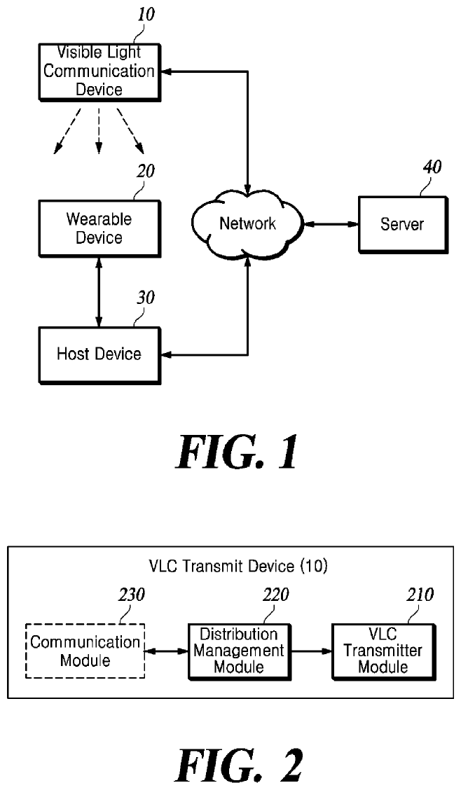

FIG. 1 is a diagram of an exemplary overall configuration of a visible light communication-based information providing system according to at least one embodiment of the present disclosure.

An information providing system 1 may include a visible light communication (VLC) device or VLC transmit device 10, a wearable device 20, and a host device 30. The VLC transmit device 10 may be, for example, a lighting device, a signage device, or a digital TV. The wearable device 20 may be, for example, a smartwatch, smart glasses, or other types of accessory devices. The host device 30 may be, for example, a cellular device (such as a smartphone), a tablet computer, a laptop computer.

The VLC transmit device 10 broadcasts a VLC signal containing the data to be distributed. When the VLC signal broadcast by the VLC transmit device 10 illuminates the wearable device 20, for example, at its image sensor and/or optical sensor, the wearable device 20 may receive the VLC signal. In some embodiments, the VLC signal includes an identifier of the VLC transmit device 10. In some embodiments, the VLC signal includes content data such as event information or guidance information, e.g., geographic location, coupon, menu, new product guidance, etc.

Upon receiving the VLC signal, the wearable device 20 may deliver or forward data included in the received VLC signal to the host device 30. In some embodiments, the wearable device 20 demodulates the data packet from the VLC signal and delivers or forwards the demodulated data packet to the host device 30.

The wearable device 20 may communicate with the host device 30 by using radio frequency (RF) communication. For example, the wearable device 20 may communicate directly with the host device 30 via short-range wireless communications. In some cases, the short-range wireless communication may be or include Bluetooth or WiFi direct. In some cases, wearable device 20 may communicate with host device 30 via a wide-area network 130. In some cases, the wide-area network may be or include the Internet. In some other cases, the wide-area network may be or include a cellular network.

By using the data packet transmitted from the wearable device 20, the host device 30 provides a service to the user. In some embodiments, the data packet includes an identifier of the VLC transmit device 10. The host device 30 may obtain, from the server 40 via the network, content corresponding to the identifier of the VLC transmit device 10. In some embodiments, the data packet includes content information. The host device 30 may display content information provided to the user.

Although FIG. 1 illustrates shows a single unit for each of the VLC transmit device 10, the wearable device 20, the host device 30, and the server 40, it should be noted that there may be multiple VLC transmit devices, wearable devices, host devices, and servers in the information providing system 1. Further, it should be noted that the embodiments described herein refer to the singular form of the VLC transmit device 10, the wearable device 20, the host device 30, and the server 40, although the embodiments are also applicable to the plural form of VLC transmit devices, wearable devices, host devices, and servers.

FIG. 2 is a block diagram of a VLC transmit device according to at least one embodiment of the present disclosure. The VLC transmit device 10 illustrated in FIG. 2 may be an example of the VLC transmit device 10 of FIG. 1. As shown in FIG. 2, the VLC transmit device 10 includes a VLC transmitter module 210 and a distribution management module 220.

The VLC transmitter module 210 may include one or more light emitting elements for transmitting VLC signals. The one or more light emitting elements may be or include one or more LEDs. The one or more light emitting elements may include one or more light emitting elements dedicated to VLC and/or one or more light emitting elements that provide other functionality. In the latter case and as an example, the one or more light emitting elements may include one or more LEDs that provide illumination for light bulbs, one or more LEDs included in the backlight of LCDs, one or more OLEDs of OLED displays, and/or one or more LEDs that serve as an indicating lamp on devices.

The distribution management module 220 is configured to broadcast a VLC signal including distribution data by using the VLC transmitter module. For example, the distribution management module 220 may be broadcast within the VLC signal through the one or more light emitting elements of the VLC transmitter module 210. In some cases, the distribution data may be broadcast within VLC signals by modulating the one or more light emitting elements. In some cases, the light-emitting element may be modulated at a frequency that makes the modulation non-perceptible to the human eye. In some embodiments, the distribution data includes an identifier of the VLC transmit device 10. In some embodiments, the distribution data includes content information.

In some embodiments, the VLC transmit device 10 further includes a (wired or wireless) communication module 230 for performing communication with a server on the network. The communication module 230 may include, for example, an Ethernet transceiver, a WLAN (e.g., WiFi) transceiver, and/or a cellular transceiver. The cellular transceiver may in some cases include an LTE/LTE-A transceiver. The communication module 230 may be used to send and receive various types of data and/or control signals to and from the server 40 on the network. In some embodiments, the distribution management module 220 may be used to receive distribution data and a distribution schedule from the server 40 on the network via a communication module. The distribution information management module 220 may broadcast a VLC signal including distribution data according to a distribution schedule.

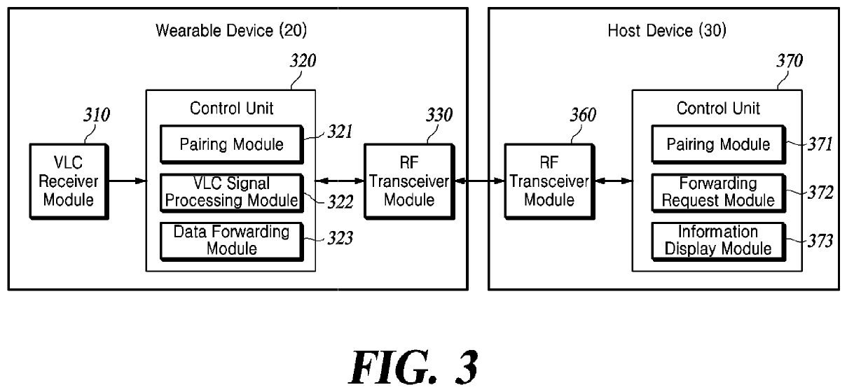

FIG. 3 is a block diagram of a wearable device and a host device paired with each other according to at least one embodiment of the present disclosure. FIG. 3 illustrates a wearable device 20 which may be an example of the wearable device 20 illustrated in FIG. 1. FIG. 3 illustrates a host device 30 which may be an example of the host device 30 illustrated in FIG. 1.

The wearable device 20 includes a VLC receiver module 310, a control unit 320, and an RF transceiver module 330.

The VLC receiver module 310 may include an image sensor and/or ambient light sensor for receiving VLC signals, for example, from one or more VLC transmit devices, specifically, from the VLC transmit device 10 described with reference to FIGS. 2 and/or 3. In some embodiments, the image sensor may be provided by a camera provided in the wearable device 20, which may be used to receive VLC signals when not being used to take a picture. In some embodiments, the image sensor and/or the ambient light sensor may be activated for purposes of receiving VLC signals when a user presses a button on the wearable device 20, touches its touch panel, or receives a request from the host device 30 paired therewith.

The RF transceiver module 330 may include, for example, a WLAN (e.g., WiFi) transceiver, a Bluetooth transceiver, and/or a cellular transceiver. The cellular transceiver may in some cases include an LTE/LTE-A transceiver. The RF transceiver module 330 may be used to deliver a data packet included in the VLC signal to the host device 20. The RF transceiver module 330 may be used to receive various types of data and/or control signals from the host device 20 over one or more RF communication channels. The RF transceiver module 330 may be used to transmit various types of data and/or control signals over one or more RF communication channels to the host device 20.

The control unit 320 controls the general operation of the wearable device 20 and operations related to the forwarding of the VLC data packet. The control unit 320 may include a pairing module 321, a VLC signal processing module 322, and a data forwarding module 323.

The pairing module 321 manipulates pairing operations between the host device 30 and the wearable device 20. The pairing operations include, for example, an operation for pairing/associating the wearable device 20 with the host device 30, unpairing/disassociating the wearable device 20 from the host device 30, and the like. In addition, the pairing module 321 enables communications between the host device 30 and the wearable device 20. In some embodiments, the pairing module 321 may receive a request for pairing from host device 30. The pairing request may be received by using the RF transceiver module 330. The pairing module 321 may then send the acceptance of the pairing request to the host device 30. The acceptance may be transmitted by using the RF transceiver module 330.

The VLC signal processing module 322 receives the VLC signal and manipulates operations to obtain the VLC data packet. The VLC signal processing module 322 may demodulate the data packet from the electrical signal outputted from the image sensor and/or the ambient light sensor of the VLC receiver module 310.

The data forwarding module 323 may be used to transmit the VLC data packet to the host device 30 in response to receiving the VLC signal and while the wearable device 20 is linked with the host device 30.

On the other hand, the host device 30 may include an RF transceiver module 360, a pairing module 371, a forwarding request module 372, and an information display module 373.

The RF transceiver module may include, for example, a WLAN (e.g., WiFi) transceiver, a Bluetooth transceiver, and/or a cellular transceiver. The cellular transceiver may in some cases include an LTE/LTE-A transceiver. The RF transceiver module may be used to receive various types of data and/or control signals from the wearable device 20 over one or more RF communication channels. The RF transceiver module may be used to transmit various types of data and/or control signals over one or more RF communication channels to the wearable device 20. In some embodiments, the RF transceiver module may be used to receive/transmit various types of data from/to a server on the network.

A control unit 370 controls the general operation of the host device 30 and the operation related to obtaining the VLC data packet received by the wearable device 20. The control unit 370 may include the pairing module 371, the forwarding request module 372, and the information display module 373.

The pairing module 371 manipulates pairing operations between the wearable device 20 and the host device 30. The pairing operations include, for example, an operation for pairing/associating the wearable device 20 with the host device 30, unpairing/disassociating the wearable device 20 from the host device 30, and the like. In addition, the pairing module 371 enables communications between the wearable device 20 and the host device 30.

While being linked with the paired wearable device 20, the forwarding request module 372 requests the wearable device 20 to forward the VLC data packet.

The information display module 373 uses the VLC data forwarded from the wearable device 20 to provide the user with an information service. In some embodiments, the data packet includes an identifier of the VLC transmit device 10, and the information display module 373 may obtain, from the server 40 via the network, content corresponding to the identifier of the VLC transmit device 10. In some embodiments, the data packet includes content information, and the information display module may display content information offered to the user.

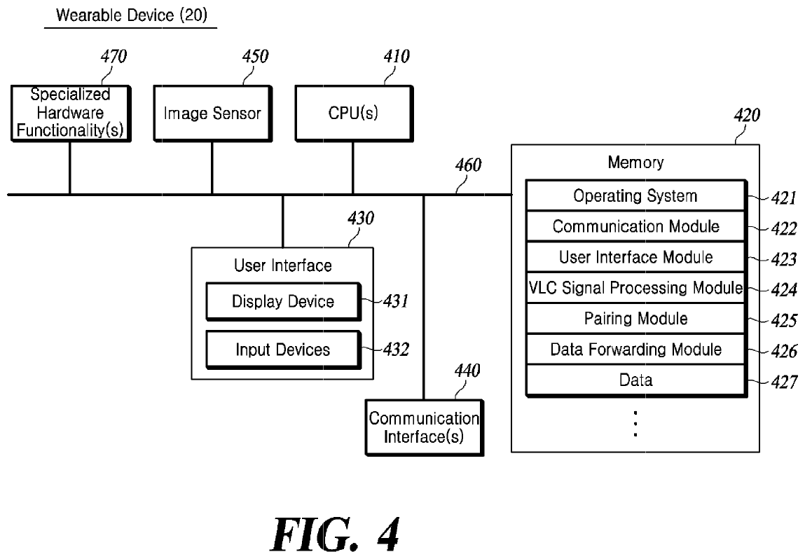

FIG. 4 is a block diagram of a wearable device according to at least one embodiment of the present disclosure. FIG. 4 illustrates a wearable device 20 which may be an example of the wearable device 20 illustrated in FIG. 1 and/or the wearable device 20 illustrated in FIG. 3.

The wearable device 20 typically includes one or more CPUs (sometimes called processors) 410 for executing programs, a memory 420 which may store the programs, one or more communication interfaces 440, an image sensor 450, and one or more communication buses 460 for interconnecting these components. The communication buses 460 may include circuitry (sometimes referred to as a chipset) that interconnects and controls communications between system components. The wearable device 20 includes a user interface 430 that includes a display device 431 and input devices 432 (e.g., touch screen, buttons, etc.).

The image sensor 450 may be used for the wearable device 20 to receive VLC signals. The image sensor 450 may be an example component of the VLC receiver module 310 shown in FIG. 3. In some cases, the image sensor 450 may be a CMOS image sensor. In some cases, the image sensor 450 may be replaced by an ambient light sensor including one or more photodiodes.

The wearable device 20 also includes one or more specialized hardware functionalities 470 (e.g., accelerometers, magnetometers, temperature sensors, microphones, speakers, input devices, etc.). The memory 420 includes random access memory, such as DRAM, SRAM, and DDR RAM, and it typically further includes non-volatile memory, such as one or more magnetic disk storage devices, optical disk storage devices, flash memory devices. The memory 420, alternatively, the non-volatile memory in the memory 420, includes a non-transitory computer-readable storage medium. In some embodiments, the memory 420 or the computer-readable storage medium of the memory 420 stores the following programs, modules, and data structures:
an operating system 421 which includes procedures for manipulating various basic system services and performing hardware dependent tasks;
a communication module 422 used to link the wearable device 20 to computers or other devices via the one or more communication interfaces 440 and one or more communication networks (e.g., the Internet, other wide-area networks, local area networks, etc.);
a user interface module 423 which receives commands from a user via the input devices 432 and generates user interface objects to the display device 431;
a VLC signal processing module 424 which controls the operation of the image sensor 450 and demodulates the VLC data from the electrical signal outputted from the image sensor 450, as described herein;
a pairing module 425 which performs pairing operations and establishes a connection to enable communication between the host device 30 and the wearable device 20, as described herein;
a data forwarding module 426 which delivers the data packet that the VLC signal processing module 424 provides to the host device while the wearable device 20 is linked with the host device, as described herein; and
pairing data 427 including information related to devices (e.g., wearable device 20) which are currently paired or previously paired with the host device 30, as described herein.

In some embodiments, these programs or modules correspond to sets of instructions for performing the functions described in connection with FIG. 3. The sets of instructions may be executed by one or more processors (e.g., CPUs 410).

FIG. 4 is intended more as a functional description of various functions that may be present in the wearable device according to embodiments described herein rather than as a structural schematic of such a wearable device. In implementation and as will be appreciated by those of ordinary skill in the art, items shown separately may be combined and some items may be separated.

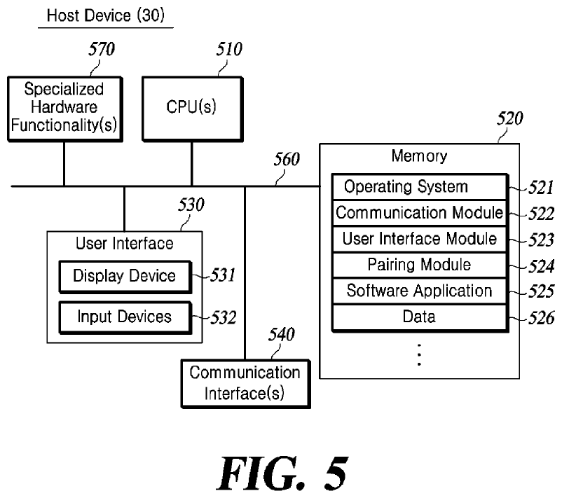

FIG. 5 is a block diagram of a host device according to at least one embodiment of the present disclosure. FIG. 5 illustrates a host device 30 which may be an example of the wearable device 20 illustrated in FIG. 1 and/or the host device 30 illustrated in FIG. 3.

The host device 30 typically includes one or more processing units 510 (CPUs sometimes referred to as processors) for executing programs, one or more communication interfaces 540, a memory 520 which may store the programs, and one or more communication buses 560 for interconnecting these components. The communication buses 560 may include circuitry (sometimes referred to as a chipset) which interconnects and controls communications between system components.

The host device 30 includes a user interface 530 which includes a display device 531 and input devices 532 (e.g., a keyboard, mouse, touch screen, keypad, etc.). The host device 30 also includes one or more hardware functionalities 570 (e.g., accelerometers, magnetometers, temperature sensors, embedded cameras, microphones, and speakers).

The memory 520 includes random access memory, such as DRAM, SRAM, and DDR RAM, and it typically further includes non-volatile memory, such as one or more magnetic disk storage devices, optical disk storage devices, flash memory devices. The memory 520, alternatively, the non-volatile memory(s) in the memory 520, includes a non-transitory computer-readable storage medium. In some embodiments, the memory 520 or the computer-readable storage medium of the memory 520 stores the following programs, modules, and data structures:
an operating system 521 which includes procedures for manipulating various basic system services and performing hardware dependent tasks;
a communication module 522 used to link the host device 30 to other devices via the one or more (wired or wireless) communication interfaces 540 and one or more communication networks, e.g., the Internet, other wide-area networks, local area networks, etc;
a user interface module 523 which receives commands from a user via the input devices 532 and generates user interface objects to the display device 531;
a pairing module 524 which performs pairing operations and establishes a connection to enable communication between the host device 30 and the wearable device 20, as described herein;
a software application 525 as described herein, which requests the wearable device 20 to forward VLC data and utilizes the forwarded VLC data from the wearable device 20 to provide the user with information services, wherein the software application 525 may be an example of the forwarding request module 372 and the information display module 373 shown in FIG. 3; and
pairing data 526 including information related to devices that are currently paired (or previously paired) with the host device 30, as described herein.

In some embodiments, these programs or modules correspond to sets of instructions for performing the functions described in connection with FIG. 3. The sets of instructions may be executed by one or more processors (e.g., CPUs 510).

FIG. 5 is intended more as a functional description of various functions that may be present in the host device 20 according to embodiments described herein rather than as a structural schematic of the host device 20. In implementation and as will be appreciated by those of ordinary skill in the art, items shown separately may be combined and some items may be separated.

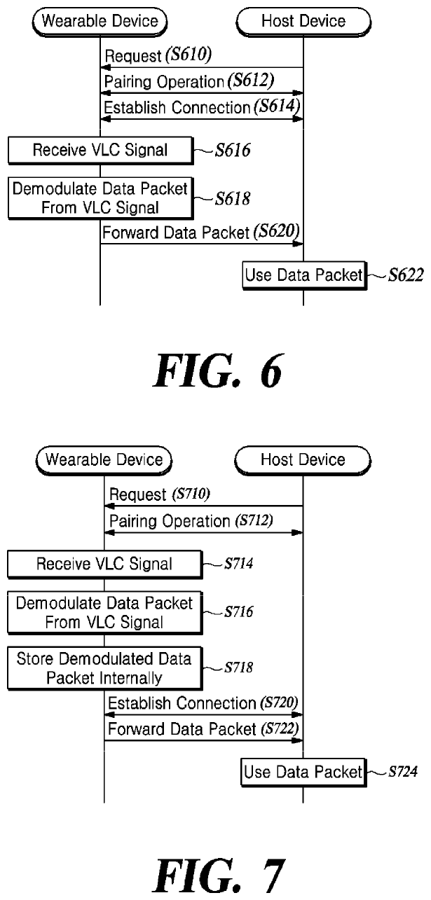

FIG. 6 is a flowchart of a VLC data forwarding method according to at least one embodiment of the present disclosure.

The host device 30 issues a request to pair with the wearable device 20 (S610). The wearable device 20 receives the request and initiates a pairing operation with the host device 30 (S612). The pairing operation bonds the two devices 20 and 30. The pairing operation is typically done when the devices 20 and 30 are first linked to each other. Once linked together, the two devices 20 and 30 may establish a connection between each other without having to perform a pairing operation again. It should also be noted that the process of pairing the two devices 20, 30 together does not refer to the presence of an activated connection between the two devices 20 and 30. For example, the host device 30 and the wearable device 20 may be linked together as a result of a previous pairing operation, but there may be no active connection between the host device 30 and the wearable device 20 due to the wearable device 20 being turned off or located outside the range of the host device 30.

During the pairing operation S612 (alternatively, after the pairing operation S612 is completed), the wearable device 20 and the host device 30 may transmit their device information to the other party and may internally store the device information received from the other party.

The paired devices 20, 30 establish a connection between them (S614). The connection may be established by using the RF transceiver module illustrated in FIG. 3. The connection may be initiated by the wearable device 20 receiving a request for connection establishment from the host device 30. After the wearable device 20 is linked to the host device 30, the host device 30 may transmit the status query and/or control information to the wearable device.

The wearable device 20 receives the VLC signal broadcast by the VLC transmit device 10 (S616). The VLC signal includes a modulated data packet. Receipt of the VLC signal may be triggered by a forwarding request from the host device 30. The wearable device 20 demodulates the data packet from the received VLC signal (S618).

The wearable device 20 transmits the demodulated data packet to the host device 30 through the established connection (S620).

The host device 30 performs one or more operations by using the data packet transmitted from the wearable device 20 (S622). In some embodiments, the data packet includes an identifier of the VLC transmit device 10, and the host device 30 may obtain content information corresponding to the identifier of the VLC transmit device 10 from the content providing server via the network. In some embodiments, the data packet includes the content information itself. The host device 30 may display content information offered to the user. For example, the host device 30 may display the location information included in the data packet (or obtained from the server) on a map, or it may display a product/service coupon or a food menu included in the data packet (or obtained from the server).

FIG. 7 is a flowchart of a VLC data forwarding method according to another embodiment of the present disclosure.

The host device 30 issues a request to pair with the wearable device 20 (S710). The wearable device 20 receives the request and initiates a pairing operation with the host device. The pairing operation bonds the two devices. As described above, the wearable device 20 and the host device 30 may be linked together as a result of a previous pairing operation, but there may be no active connection between the host device 30 and the wearable device 20 due to the wearable device 20 being turned off or located outside the range of the host device 30.

The wearable device 20 may still operate at the absence of the activated connection with the host device to receive the VLC signal broadcast by the VLC transmit device 10 and demodulate the data packet from the received VLC signal. The wearable device 20 internally stores (e.g., caches) the demodulated data packet until a connection with the host device is established.

The wearable device 20 may send a request to establish a connection with the host device 30 or receive a request to establish a connection from the host device 30. In some embodiments, the wearable device 20 may be responsive to determining that there is at least one demodulated data packet stored internally for sending a request to establish a connection with the host device 30. The host device 104 and the wearable device 106 establish a connection between them through acceptance of the request (S720). The connection may be established by using the RF transceiver modules 330, 360 illustrated in FIG. 3.

The wearable device 20 transmits the internally stored data packet to the host device 30 through the established connection (S722). In some embodiments, after the wearable device 20 is linked to the host device 30, the host device 30 may request forwarding of the VLC signal broadcast by the VLC transmit device 10 (and received before a connection is established). In some embodiments, the wearable device 20 may deliver its internally stored data packets to the host device 30 in response to establishing a connection between them without having to wait for a forwarding request from the host device 30.

The host device 30 performs one or more operations by using the data packet transmitted from the wearable device 20 (S724). In some embodiments, the data packet includes an identifier of the VLC transmit device 10, and the host device 30 may obtain content information corresponding to the identifier of the VLC transmit device 10 from the server over the network. In some embodiments, the data packet includes the content information itself. The host device 30 may display content information to the user.

In some embodiments, the wearable device 20 determines whether the content information included in the data packet is of a type that is supportable by its hardware functionality (e.g., may be displayed by the wearable device). For example, when the content information is of a compatible type, such as text and a small image, the wearable device 20 may show the content information by its display device before delivering the content information to the host device 30 or by skipping the delivery of the same to the host device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

1. A method performed by a wearable device, comprising:
performing a pairing with a host device to have a paired host device;
receiving a visible light communication (VLC) signal broadcast from a visible light transmit device; and
forwarding a data packet included in the VLC signal to the paired host device.

2. The method of claim 1, further comprising:
establishing a connection with the paired host device.

3. The method of claim 1, wherein the establishing of the connection with the paired host device is performed before the receiving of the VLC signal.

4. The method of claim 1, wherein the establishing of the connection with the paired host device is performed after the receiving of the VLC signal.

5. The method of claim 1, wherein the data packet includes an identifier of the visible light transmit device.

6. The method of claim 1, wherein the data packet includes content information.

7. The method of claim 1, wherein the wearable device comprises a smartwatch, and the host device comprises a smartphone in short-range wireless communication with the smartwatch.

8. A wearable device, comprising:
at least one processor;
a memory; and
at least one program stored in the memory and executable by the at least one processor, wherein
the at least one program comprises:
instructions for performing a pairing with a host device to have a paired host device;
instructions for receiving a visible light communication (VLC) signal broadcast from a visible light transmit device; and
instructions for forwarding a data packet included in the VLC signal to the paired host device.

9. The wearable device of claim 8, wherein the at least one program further comprises:
instructions for establishing a connection with the paired host device.

10. The wearable device of claim 8, wherein the data packet includes an identifier of the visible light transmit device.

11. The wearable device of claim 8, wherein the data packet includes content information.

12. A wearable device, comprising:
a means configured to receive a visible light communication (VLC) signal broadcast from a visible light transmit device;
a means configured to perform a pairing with a host device to have a paired host device;
a means configured to establish a connection with the paired host device; and
a means configured to forward a data packet included in the VLC signal to the paired host device.

13. The wearable device of claim 12, wherein the means configured to receive the VLC signal comprises:
an image sensor or an optical sensor.

14. The wearable device of claim 12, wherein the connection with the paired host device is made through short-range wireless communications.
